(19) United States
(12) Patent Application Publication
(10) Pub. No.: US 2020/0200664 A1
(43) Pub. Date: Jun. 25, 2020

(54) PARTICLE COUNTER

(71) Applicant: NGK INSULATORS, LTD., Nagoya-City (JP)

(72) Inventors: Keiichi KANNO, Nagoya-City (JP); Kazuyuki MIZUNO, Nagoya-City (JP); Hidemasa OKUMURA, Nagoya-City (JP)

(73) Assignee: NGK INSULATORS, LTD., Nagoya-City (JP)

(21) Appl. No.: 16/807,746

(22) Filed: Mar. 3, 2020

Related U.S. Application Data
(63) Continuation of application No. PCT/JP2018/029118, filed on Aug. 2, 2018.

(30) Foreign Application Priority Data
Sep. 6, 2017 (JP) 2017-170810

(51) Int. Cl. G01N 15/02; G01N 15/14; B03C 3/41

(52) U.S. Cl. CPC G01N 15/0266; G01N 15/14; G01N 2015/0046; G01N 2015/1486; B03C 3/41

(57) ABSTRACT

A particle counter includes a charge generation unit that applies charges generated by discharge to particles in a gas introduced into a gas flow channel to generate charged particles, a collection electrode that collects the charged particles, and a counting unit that determines the number of particles on the basis of a physical quantity that changes in accordance with the number of charged particles collected by the collection electrode. The counting unit determines an average number of charges on the particles using a relationship between a particle diameter and a probability density of the particles and a relationship between the particle diameter and the number of charges on the particles, and determines the number of particles on the basis of the physical quantity and the average number of charges on the particles.

### BACKGROUND OF THE INVENTION

### 1. Field of the Invention

The present invention relates to a particle counter.

### 2. Description of the Related Art

There is known a particle counter that charges particles in a measurement-object gas by using ions generated by corona discharge, generates a measurement signal correlated with the particles in the measurement-object gas, and determines the number of particles in the measurement-object gas on the basis of the measurement signal (see, for example, PTL 1). This particle counter estimates a particle diameter of the particles in the measurement-object gas and corrects the number of particles using a coefficient related to the ratio between the estimated particle diameter and a reference particle diameter. As an example of the particle diameter, a particle diameter peak value (the value of the particle diameter at which the number of particles is the largest in a particle diameter distribution of particles contained in an exhaust gas emitted during the operation of an internal combustion engine under predetermined operating conditions) is provided.

### CITATION LIST

### Patent Literature

PTL 1: Japanese Unexamined Patent Application Publication No. 2016-75674

### SUMMARY OF THE INVENTION

When there are two measurement-object gases with the same particle diameter peak value and different particle diameter distributions of particles, the numbers of particles in the two measurement-object gases would have different values. In PTL 1, however, correction coefficients have the same value if particle diameter peak values are the same, and thus the numbers of particles after correction also have the same value, which is problematic. Accordingly, the measurement accuracy of the number of particles is not high.

The present invention has been made to address such a problem, and it is a main object of the present invention to provide high-accuracy measurement of the number of particles.

A particle counter according to the present invention includes
a housing having a gas flow channel,
a charge generation unit that applies charges generated by discharge to particles in a gas introduced into the gas flow channel to generate charged particles,
a collection electrode that is disposed downstream of the charge generation unit in a flow of the gas and that collects the charged particles, and
a counting unit that determines the number of particles in the gas on the basis of a physical quantity that changes in accordance with the number of charged particles collected by the collection electrode, wherein
the counting unit determines an average number of charges on the particles using a relationship between a particle diameter and a probability density of the particles and a relationship between the particle diameter and the number of charges on the particles, and determines the number of particles in the gas using the physical quantity and the average number of charges on the particles.

To determine the number of particles in a gas, the particle counter described above determines an average number of charges on the particles using a relationship between a particle diameter and a probability density of the particles and a relationship between the particle diameter and the number of charges on the particles, and determines the number of particles using the average number of charges on the particles and a physical quantity that changes in accordance with the number of charged particles collected by the collection electrode. Accordingly, for example, when there are two gases with the same particle diameter peak value and different particle diameter distributions of particles, the numbers of particles, which are obtained for the respective gases, have different values since the different particle diameter distributions of the particles result in different relationships between the particle diameter and the probability density of the particles. Therefore, the measurement accuracy of the number of particles is higher than that in the related art.

The term “charges”, as used herein, is used to include positive charges and negative charges, and is also used to include ions. The term “physical quantity” refers to any parameter that changes in accordance with the number of charged particles (charge amount), examples of which include current.

In the particle counter according to the present invention, the gas may be an exhaust gas of an engine, and the counting unit may determine the relationship between the particle diameter and the probability density of the particles on the basis of an operating condition of the engine. Since a particle diameter distribution of particles changes in accordance with operating conditions of an engine, a relationship between a particle diameter and a probability density of the particles also changes. Here, the determination of the relationship between the particle diameter and the probability density of the particles is based on the operating conditions of the engine, and thus the measurement accuracy of the number of particles is further increased. Examples of the operating condition of the engine include a rotational speed and a torque of the engine.

In the particle counter according to the present invention, the average number of charges on the particles may be determined by accumulating products each obtained by multiplying the number of charges for a particle diameter of one of the particles and a probability density for a particle diameter of one of the particles. This enables accurate determination of the average number of charges on the particles.

In the particle counter according to the present invention, the counting unit may determine the relationship between the particle diameter and the number of charges on the particles with consideration given to at least one of a temperature of the gas or a flow velocity of the gas. Even for particles having the same particle diameter, the numbers of charges change in accordance with the temperature of the gas or the flow velocity of the gas. Accordingly, the determination of the number of charges based on the particle diameter of the particles and at least one of the temperature of the gas or the flow velocity of the gas results in more accurate determination of the number of charges than the determination of the number of charges based on merely the particle diameter of the particles. Therefore, the measurement accuracy of the number of particles is further increased.

In this case, the counting unit may determine the relationship between the particle diameter and the number of charges on the particles by using a power approximation formula that takes into consideration at least one of a temperature of the gas or a flow velocity of the gas. When relationships between particle diameters and the numbers of charges on the particles are actually measured while changing at least one of the temperature of the gas or the flow velocity of the gas, the particle diameters are set discretely. With the use of a power approximation formula, the particle diameters have consecutive values via interpolation. Accordingly, the number of charges for a particle diameter of the particles can be more accurately determined.

The particle counter according to the present invention may further include an excess charge removal electrode that is disposed between the charge generation unit and the collection electrode and that removes excess charges not applied to the particles. Since excess charges are removed by the excess charge removal electrode, such excess charges can be prevented from being collected by the collection electrode and from being counted in the number of particles.

### BRIEF DESCRIPTION OF THE DRAWINGS

FIG. 1 is a sectional view illustrating a schematic configuration of a particle counter 10.

FIG. 2 is a flowchart of a particle counting process.

FIG. 3 is a graph of a particle diameter distribution of particles.

FIG. 4 is a graph of particle diameter distributions of particles.

FIG. 5 is a graph illustrating relationships between the particle diameter and the probability density of particles.

FIG. 6 is a diagram illustrating a charge count measurement device 80.

FIG. 7 illustrates particle diameter distributions of soot particles before and after charging.

FIG. 8 is a graph illustrating relationships between the particle diameter and the number of charges on soot particles for gas temperatures.

FIG. 9 is a graph illustrating relationships between the particle diameter and the number of charges on soot particles for gas flow velocities.

FIG. 10 is a diagram illustrating another example of an excess charge removal electrode 30 and a collection electrode 40.

### DETAILED DESCRIPTION OF THE INVENTION

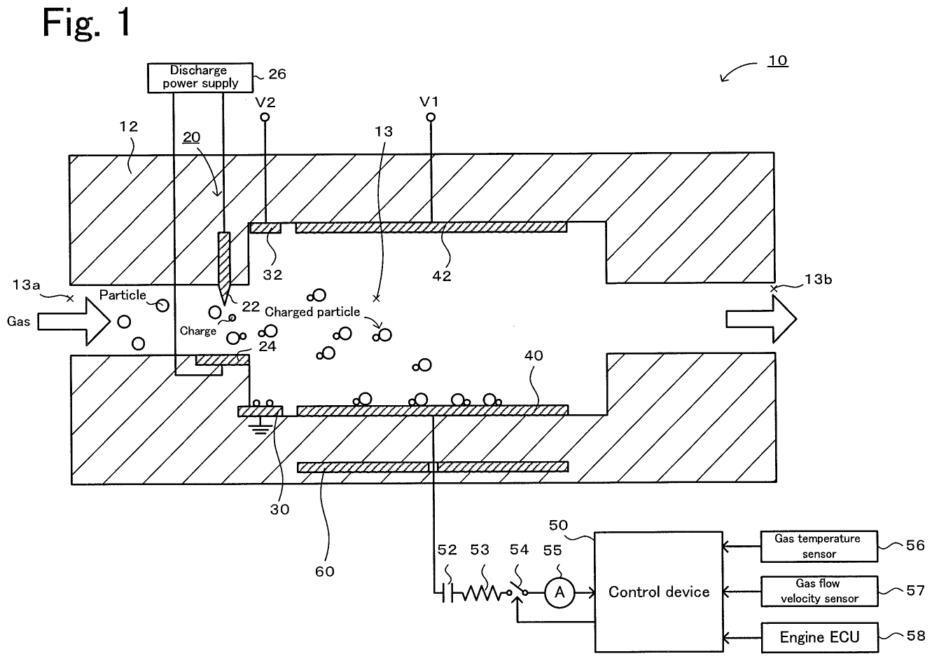

A preferred embodiment of the present invention will be described hereinafter with reference to the drawings. FIG. 1 is a sectional view illustrating a schematic configuration of a particle counter 10.

The particle counter 10 measures the number of particles contained in a gas (here, an exhaust gas of an engine of a motor vehicle). The particle counter 10 includes a housing 12, a charge generation element 20 (charge generation unit), an excess charge removal electrode 30, a collection electrode 40, a control device 50 (counting unit), and a heater 60.

The housing 12, which is made of an insulating material, has a gas flow channel 13. The gas flow channel 13 extends through the housing 12 from a gas inlet 13a to a gas outlet 13b. Examples of the insulating material include a ceramic material. Non-limiting types of the ceramic material include alumina, aluminum nitride, silicon carbide, mullite, zirconia, titania, silicon nitride, magnesia, glass, and mixtures thereof. In the gas flow channel 13, the charge generation element 20, the excess charge removal electrode 30, and the collection electrode 40 are disposed to be arranged along the gas flow from the upstream side toward the downstream side of the gas flow (here, in the direction from the gas inlet 13a to the gas outlet 13b) in the stated order.

The charge generation element 20, which is disposed on the side of the gas flow channel 13 close to the gas inlet 13a, has a needle-shaped electrode 22 and a counter electrode 24 disposed so as to be exposed from a wall facing the needle-shaped electrode 22. The needle-shaped electrode 22 and the counter electrode 24 are coupled to a discharge power supply 26 that applies a voltage Vp (for example, a pulse voltage or the like). The voltage Vp is applied between the needle-shaped electrode 22 and the counter electrode 24 of the charge generation element 20, thereby generating a gaseous discharge due to a potential difference between both electrodes. The passage of a gas through the gaseous discharge allows charges (here, positive charges) to be applied to the particles in the gas to generate charged particles.

The excess charge removal electrode 30 is disposed along an inner surface of the gas flow channel 13. The excess charge removal electrode 30 removes charges not applied to the particles. An electric field generation electrode 32 for excess charge removal is disposed in the gas flow channel 13 at a position facing the excess charge removal electrode 30. The electric field generation electrode 32 is also disposed along the inner surface of the gas flow channel 13. When a voltage V2 of a power supply for electric field generation (not illustrated) is applied between the electric field generation electrode 32 and the excess charge removal electrode 30, an electric field is generated between the electric field generation electrode 32 and the excess charge removal electrode 30 (on or above the excess charge removal electrode 30). Among the charges generated by the gaseous discharge in the charge generation element 20, charges not applied to the particles are attracted toward the excess charge removal electrode 30 due to the electric field so as to be collected by the excess charge removal electrode 30, and are disposed of on GND (ground).

The collection electrode 40 is disposed along the inner surface of the gas flow channel 13. The collection electrode 40 collects the charged particles. An electric field generation electrode 42 for collection is disposed in the gas flow channel 13 at a position facing the collection electrode 40. The electric field generation electrode 42 is also disposed along the inner surface of the gas flow channel 13. When a voltage V1 of a power supply for electric field generation (not illustrated) is applied between the electric field generation electrode 42 and the collection electrode 40, an electric field is generated between the electric field generation electrode 42 and the collection electrode 40 (on or above the collection electrode 40). The charged particles are attracted toward the collection electrode 40 due to the electric field so as to be collected by the collection electrode 40. The collection electrode 40 is connected to an ammeter 55 via a capacitor 52, a resistor 53, and a switch 54. The switch 54 is preferably a semiconductor switch. When the collection electrode 40 and the ammeter 55 are electrically connected to each other by turning on the switch 54, a current based on the charges applied to the charged particles that adhere to the collection electrode 40 is transmitted to the ammeter 55 as a transient response via a series circuit including the capacitor 52 and the resistor 53.

The sizes of the electrodes 30 and 40 and the strengths of the electric fields on or above the electrodes 30 and 40 (the magnitudes of the voltages V1 and V2) are set so that the charged particles are collected by the collection electrode 40 without being collected by the excess charge removal electrode 30 and, in addition, the charges that do not adhere to the particles are collected by the excess charge removal electrode 30.

The control device 50 is constituted by a known microcomputer including a CPU, a ROM, a RAM, and so on. The control device 50 receives, from the ammeter 55, the current flowing through the collection electrode 40, receives the temperature of the exhaust gas and the flow velocity of the exhaust gas from a gas temperature sensor 56 and a gas flow velocity sensor 57 attached to an exhaust pipe of the engine, respectively, or receives the torque and rotational speed of the engine from an engine ECU 58 that controls the engine. Further, the control device 50 computes the number of particles. A gas flow rate sensor may be used in place of the gas flow velocity sensor 57. In this case, the gas flow velocity can be determined by dividing the gas flow rate by the cross-sectional area of the passage.

The heater 60 is embedded in the wall of the gas flow channel 13 at a position near the collection electrode 40. The heater 60, which is coupled to a feeder device (not illustrated), generates heat upon energization from the feeder device to heat the collection electrode 40. If a large number of particles and the like are deposited on the collection electrode 40, no further charged particles may be collected by the collection electrode 40. Accordingly, the control device 50 causes the heater 60 to heat the collection electrode 40 periodically or at the timing when the amount of deposition reaches a predetermined amount to heat and incinerate the substances deposited on the collection electrode 40 such that the electrode surface of the collection electrode 40 is refreshed.

Next, an example of use of the particle counter 10 will be described. To measure particles contained in an exhaust gas of a motor vehicle, the particle counter 10 is attached to the inside of an exhaust pipe of an engine. At this time, the particle counter 10 is placed so that the exhaust gas is introduced into the gas flow channel 13 from the gas inlet 13a of the particle counter 10 and is discharged from the gas outlet 13b.

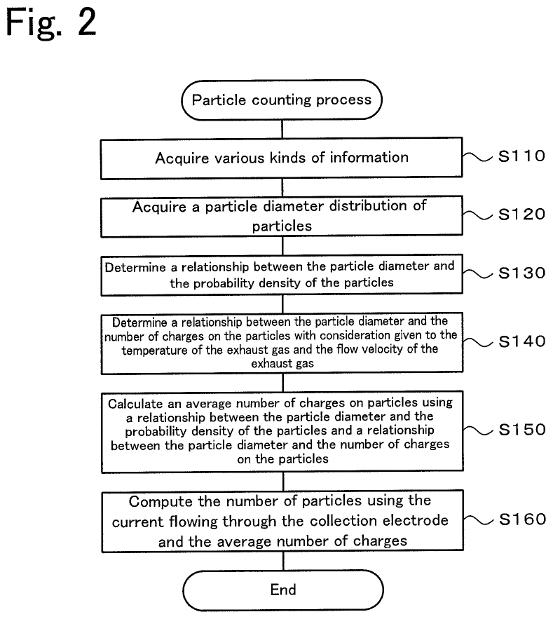

The control device 50 reads a particle counting processing program stored in the ROM and executes the particle counting processing program at each timing at which a particle counting process starts. A flowchart of the particle counting process is illustrated in FIG. 2.

When the particle counting process begins, the control device 50 first acquires various kinds of information (step S110). Specifically, the control device 50 receives the temperature of the exhaust gas from the gas temperature sensor 56, receives the flow velocity of the exhaust gas from the gas flow velocity sensor 57, receives the torque and rotational speed of the engine from the engine ECU 58, and receives, from the ammeter 55, the current flowing through the collection electrode 40.

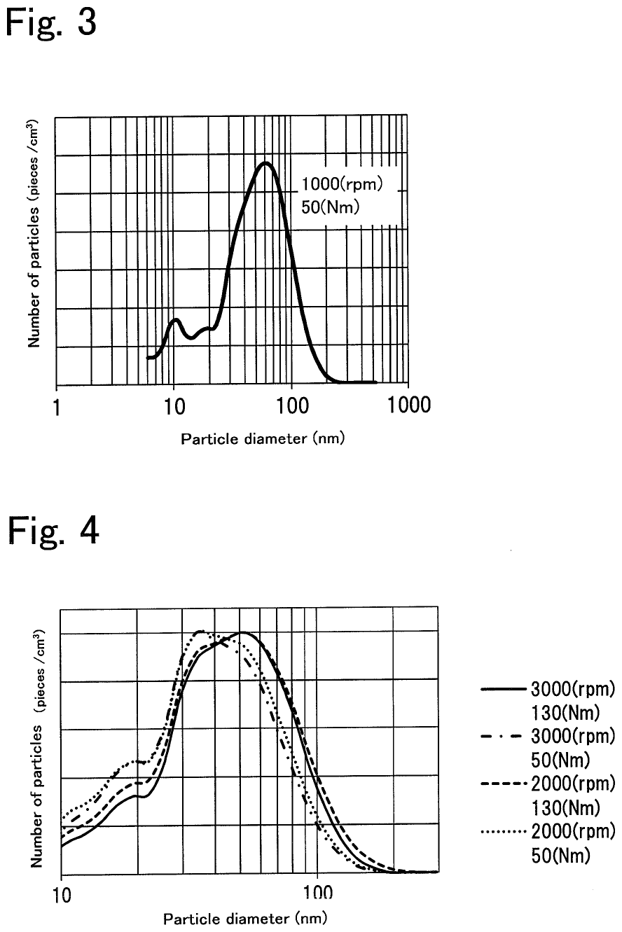

Then, the control device 50 acquires a particle diameter distribution of particles on the basis of the torque and rotational speed of the engine (step S120). An example of results of actual measurement of a particle diameter distribution of particles contained in the exhaust gas is illustrated in FIGS. 3 and 4. FIG. 3 illustrates a result of actual measurement when the rotational speed of the engine is set to 1000 rpm and the torque of the engine is set to 50 N·m. FIG. 4 illustrates results of actual measurement when the rotational speed of the engine is set to 2000 rpm and 3000 rpm and the torque of the engine is set to 50 N·m and 130 N·m. FIGS. 3 and 4 indicate that a particle diameter distribution of particles changes in accordance with the operating conditions of the engine. A storage device (not illustrated) (such as the ROM) of the control device 50 stores respective particle diameter distributions of particles in association with torques and rotational speeds of the engine. Thus, in step S120, the control device 50 reads a particle diameter distribution of particles for the currently obtained torque and rotational speed of the engine from the storage device.

Then, the control device 50 determines a relationship between the particle diameter and the probability density of the particles (step S130). Specifically, the control device 50 accumulates particle counts for respective particles in data of the particle diameter distribution of the particles to determine a total particle count, divides a particle count for each particle by the total particle count, and normalizes the results to convert the vertical axis of the particle diameter distribution to probability densities of the particles. A graph obtained by converting the particle diameter distribution of the particles illustrated in FIG. 3 to the probability density function (a graph illustrating an example of a relationship between the particle diameter and the probability density of the particles) is indicated by a solid line in FIG. 5. A region defined by the solid-line curve and the horizontal axis has an area of 1.

Then, the control device 50 determines a relationship between the particle diameter and the number of charges on the particles with consideration given to the temperature of the exhaust gas and the flow velocity of the exhaust gas (step S140).

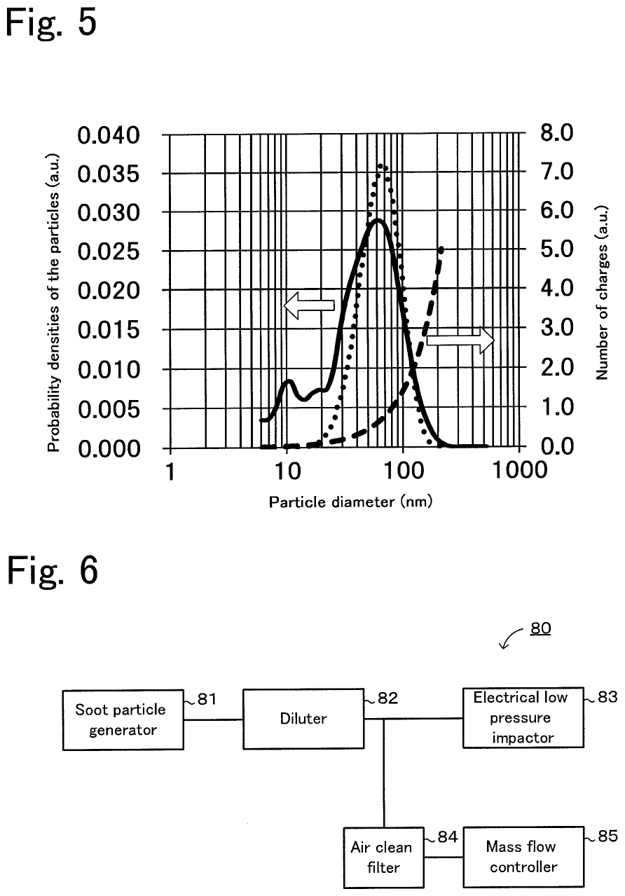

A relationship between the particle diameter and the number of charges on the particles will now be described. The relationship is determined in advance through an experiment. The experiment can be conducted by using a charge count measurement device 80 illustrated in FIG. 6, for example. The charge count measurement device 80 is configured such that a soot particle generator 81, a diluter 82, and an electrical low pressure impactor 83 are coupled in series by connecting them using pipes and a branch from the pipe connecting the diluter 82 and the electrical low pressure impactor 83 is joined to a mass flow controller (MFC) 85 via an air clean filter 84.

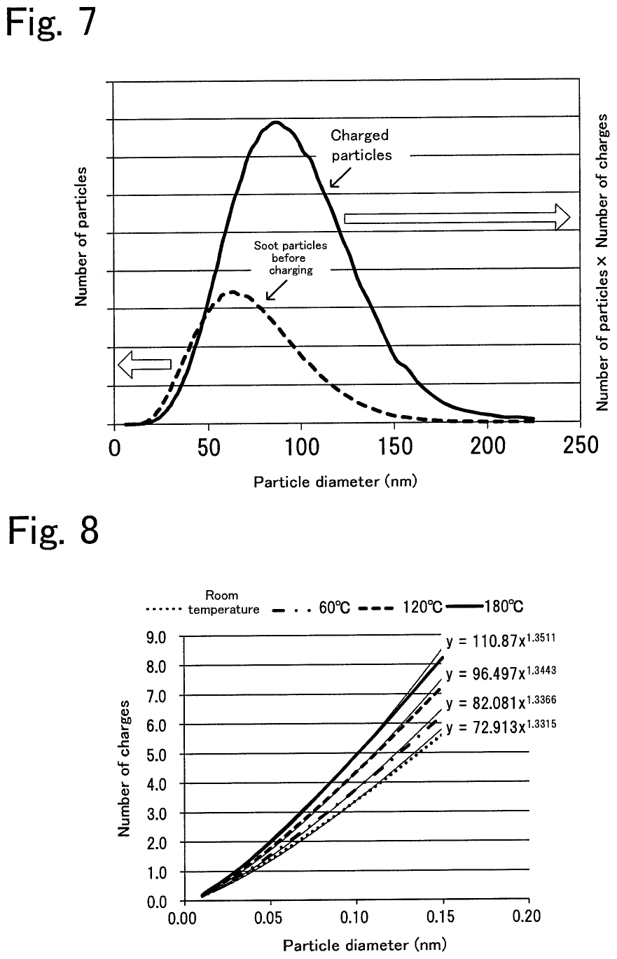

The soot particle generator 81 is a device that generates soot particles by discharge. Examples of the device include PALAS DNP 3000. An example of a particle diameter distribution of the generated soot particles before charging is indicated by a broken line in FIG. 7. The particle diameter distribution of the soot particles has a pattern similar to that of a normal distribution, and the particle diameters are in the range of 30 to 200 nm. In this case, the vertical axis represents the number of soot particles.

The diluter 82 is a device that dilutes a particle-containing gas introduced from an inlet with clean air and that discharges the diluted gas from an outlet. Examples of the device include DEKATI DI-1000. The outlet flow rate can be set to a predetermined flow rate (for example, 10 L/min), and the temperature of the gas can be set as desired in the range of the room temperature to 180° C.

The electrical low pressure impactor 83 is a device including a charger unit that charges soot particles introduced from an inlet, and an impactor collection unit that collects the charged soot particles. Examples of the device include DEKATI HT ELPI+. The electrical low pressure impactor 83 is capable of performing particle diameter distribution measurement or particle charge distribution measurement in real time at a temperature set in the range of the room temperature to 180° C. An example of a particle size distribution of the charged soot particles introduced into the electrical low pressure impactor 83 is indicated by a solid line in FIG. 7. The particle size distribution of the charged soot particles is a particle size distribution obtained after the soot particles before charging at a specific temperature of the gas are charged. In this case, the vertical axis represents the value obtained by multiplying the number of charged soot particles by the number of charges. The charger unit preferably has the same configuration as the charge generation element 20, and the voltage applied between electrodes is also preferably the same as that for the charge generation element 20.

The MFC 85 controls the flow rate so that part or all of the gas discharged from the diluter 82 at a predetermined flow rate is introduced into the electrical low pressure impactor 83. Accordingly, the flow velocity of the gas to be introduced into the electrical low pressure impactor 83 can be changed as desired.

FIG. 7 indicates that the number of charges per soot particle is approximately 1 when the particle diameter is less than or equal to 50 nm and that the number of charges per soot particle exceeds 1 when the particle diameter exceeds 50 nm. For example, when the particle diameter is 100 nm, the number of charges per soot particle is approximately 4. In this way, a relationship between the particle diameter and the number of charges on the soot particles can be determined from the graph illustrated in FIG. 7.

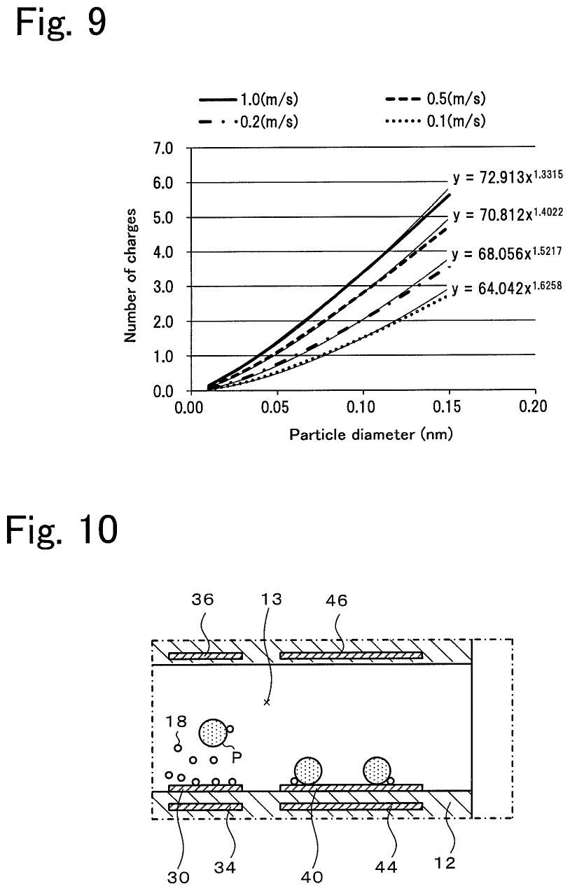

The relationship between the particle diameter and the number of charges on the soot particles changes in accordance with the temperature of a gas including soot particles or the flow velocity of a gas including soot particles. This can also be determined in advance by using the charge count measurement device 80. An example of changes in relationship between the particle diameter and the number of charges on soot particles in accordance with the temperature of the gas is illustrated in FIG. 8. FIG. 8 is a graph obtained when the flow velocity of the gas is fixed to 1 m/s. FIG. 8 indicates that as the temperature of the gas increases from the room temperature (22° C.) to 60° C., 120° C., and 180° C., the number of charges increases even for particles having the same particle diameter. An example of changes in relationship between the particle diameter and the number of charges on soot particles in accordance with the flow velocity of a gas including soot particles is illustrated in FIG. 9. FIG. 9 is a graph obtained when the temperature of the gas is fixed to the room temperature. FIG. 9 indicates that as the flow velocity of the gas increases from 0.1 m/s to 0.2 m/s, 0.5 m/s, and 1.0 m/s, the number of charges increases even for particles having the same particle diameter.

In FIG. 8, thin solid lines plotted so as to substantially match the curved lines based on the actual measurement of the respective temperatures are curved lines of exponential functions obtained by power approximation, and are indicated to accurately approximate to the curved lines indicating the actual measurement. In FIG. 9, thin solid lines plotted so as to substantially match the curved lines based on the actual measurement of the respective flow velocities are curved lines of exponential functions obtained by power approximation, and are indicated to accurately approximate to the curved lines indicating the actual measurement. In FIG. 8 and FIG. 9, formulas for exponential functions obtained by power approximation are indicated to the right of the respective thin solid lines. In the formulas, y denotes the number of charges and x denotes the particle diameter (μm). In this manner, it is indicated that the relationship between the particle diameter and the number of charges is not directly proportional.

The control device 50 can determine the number of charges relative to a particle diameter of the particles with consideration given to the temperature of the gas and the flow velocity of the gas by using the curved lines (thin solid lines) illustrated in FIG. 8 and FIG. 9 obtained by power approximation. Since the curved lines obtained by power approximation interpolate particle diameters other than the actually measured particle diameters, the number of charges can also be accurately estimated even for a particle diameter that is not actually measured. In addition, the distributions of the numbers of charges (relationships between the particle diameter and the number of charges on particles) based on representative temperatures of the gas or representative flow velocities of the gas are actually measured, thereby enabling interpolation of a temperature of the gas or a flow velocity of the gas that is not actually measured. This eliminates the need for thorough actual measurement of distributions of the numbers of charges based on temperatures of the gas or flow velocities of the gas.

Then, the control device 50 calculates an average number of charges on particles using a relationship between the particle diameter and the probability density of the particles (see, for example, the solid line in FIG. 5) and a relationship between the particle diameter and the number of charges on the particles (see, for example, the broken line in FIG. 5, which is generated based on the curved lines illustrated in FIG. 8 and FIG. 9 obtained by power approximation) (step S150). Specifically, the control device 50 first determines a probability density for each particle diameter using the relationship between the particle diameter and the probability density of the particles, and determines the number of charges for each particle diameter using the relationship between the particle diameter and the number of charges on the particles. Thereafter, the control device 50 determines the product of the probability density and the number of charges for each particle diameter, and accumulates the products for the target particle diameter range to obtain an expected value of the number of charges. The expected value of the number of charges is used as the average number of charges.

Then, the control device 50 computes the number of particles using the current flowing through the collection electrode 40 and the average number of charges (step S160). The particles contained in the exhaust gas introduced into the gas flow channel 13 from the gas inlet 13a carry charges (here, positive charges) generated by discharge in the charge generation element 20 to form charged particles. The charged particles move along the gas flow without being removed by the excess charge removal electrode 30, and are then collected by the collection electrode 40. Among the charges generated in the charge generation element 20, charges not applied to the particles are collected by the excess charge removal electrode 30 and are disposed of on GND. Accordingly, the current flowing through the collection electrode 40 changes in accordance with the number of charged particles. The relationship between the current I and the charge amount q is given by I=dq/(dt), or q=∫Idt. Thus, the control device 50 integrates (accumulates) the value of current from the ammeter 55 over a period during which the switch 54 is kept on (switch-on period) to determine the integral of the value of current (cumulative charge amount). After the switch-on period has elapsed, the cumulative charge amount is divided by the elementary charge to determine the total number of charges (the number of collected charges), and the number of collected charges is divided by the average of the number of charges applied per particle (the average number of charges), and the result is further divided by the gas flow rate to determine the number of particles adhering to the collection electrode 40 over a certain amount of time (for example, 5 to 15 seconds) (see the formula below). This number of particles is the number of particles per unit volume. The gas flow rate is obtained by multiplying the gas flow velocity by the cross-sectional area of the passage. Then, the control device 50 performs the computation of calculating the number of particles for the certain amount of time repeatedly over a predetermined period (for example, 1 to 5 minutes) and accumulates the results. Accordingly, the control device 50 can calculate the number of particles that adhere to the collection electrode 40 over the predetermined period. In addition, with the use of transient response of the capacitor 52 and the resistor 53, even a small current can be measured, and the particles can be counted with high accuracy. A small current of a pA (picoampere) or nA (nanoampere) level can be measured by, for example, increasing the time constant by using the resistor 53 having a large resistance value.

Number of particles=cumulative charge amount/(elementary charge×average number of charges×flow rate)

To determine the number of particles in a gas, the particle counter 10 according to this embodiment described in detail above determines an average number of charges on the particles using a relationship between a particle diameter and a probability density of the particles and a relationship between the particle diameter and the number of charges on the particles, and determines the number of particles using the current flowing through the collection electrode 40 and the average number of charges on the particles. For example, as indicated by the solid line (actually measured distribution) and a dotted line (lognormal distribution) in FIG. 5, when there are two gases with the same particle diameter peak value (approximately 65 nm) and different particle diameter distributions of particles, the numbers of particles, which are obtained for the respective gases, have different values since the different particle diameter distributions of the particles result in different relationships between the particle diameter and the probability density of the particles. As a result of calculating the average number of charges indicated by the solid line and the average number of charges indicated by the dotted line in FIG. 5 using the same temperature and flow velocity of the exhaust gas, the former is 0.65 and the latter is 0.89. In contrast, as in PTL 1, if the average number of charges is calculated using the particle diameter peak value without consideration being given to the particle diameter distributions, the former and latter average numbers of charges have the same value. According to this embodiment, therefore, the measurement accuracy of the number of particles is higher than that in the related art (PTL 1).

Furthermore, since a particle diameter distribution of particles changes in accordance with operating conditions of an engine, a relationship between a particle diameter and a probability density of the particles also changes. Accordingly, the control device 50 determines a relationship between a particle diameter and a probability density of the particles on the basis of the operating conditions of the engine. Therefore, the measurement accuracy of the number of particles is further increased.

Furthermore, the control device 50 determines the average number of charges on the particles by accumulating products each obtained by multiplying the number of charges for a particle diameter of one of the particles and a probability density for a particle diameter of one of the particles. This enables accurate determination of the average number of charges on the particles.

Furthermore, the control device 50 determines the relationship between the particle diameter and the number of charges on the particles with consideration given to the temperature and the flow velocity of the exhaust gas. Even for particles having the same particle diameter, the numbers of charges change in accordance with the temperature and the flow velocity of the exhaust gas. Accordingly, the determination of the number of charges based on the temperature and the flow velocity of the exhaust gas and the particle diameter of the particles results in more accurate determination of the number of charges than the determination of the number of charges based on merely the particle diameter of the particles. Therefore, the measurement accuracy of the number of particles is further increased.

In particular, the control device 50 determines the relationship between the particle diameter and the number of charges on the particles by using a power approximation formula that takes into consideration the temperature and the flow velocity of the exhaust gas. When relationships between particle diameters and the numbers of charges on the particles are actually measured while changing the temperature and the flow velocity of the exhaust gas, the particle diameters are set discretely. With the use of a power approximation formula, the particle diameters have consecutive values via interpolation. Accordingly, the number of charges for a particle diameter of the particles can be more accurately determined.

Moreover, since excess charges are removed by the excess charge removal electrode 30, such excess charges can be prevented from being collected by the collection electrode 40 and from being counted in the number of particles.

It goes without saying that the present invention is not limited to the embodiment described above and may be implemented in various embodiments within the technical scope of the present invention.

For example, in the embodiment described above, a relationship between a particle diameter and the number of charges on particles is determined with consideration given to both the temperature and the flow velocity of the exhaust gas. However, the determination may be performed with consideration given to any one of the temperature and the flow velocity of the exhaust gas. Alternatively, in the embodiment described above, a relationship between a particle diameter and the number of charges on particles may be determined without consideration being given to the temperature or the flow velocity of the exhaust gas. Even in this case, the average number of charges is calculated with consideration given to a particle diameter distribution, and thus the measurement accuracy of the number of particles is higher than that in the case where the average number of charges is calculated using the particle diameter peak value without consideration being given to a particle diameter distribution (PTL 1). However, the measurement accuracy of the number of particles is lower than that when consideration is given to at least one of the temperature or the flow velocity of the exhaust gas.

In the embodiment described above, the control device 50 performs steps S120 to S150 in the particle counting process (FIG. 2). However, the control device 50 may perform the following process instead of S120 to S150. That is, a relationship between a particle diameter and a probability density of particles and a relationship between a particle diameter and the number of charges on particles are actually measured in advance for each of the operating conditions of the engine (for example, the rotational speed and the torque of the engine) to calculate the average number of charges through the procedure described above, and a map (or table) in which the operating conditions of the engine and the average numbers of charges are associated with each other is stored in the storage device of the control device 50, such as the ROM. In the particle counting process, the control device 50 acquires an operating condition of the engine in step S110, and then reads the average number of charges associated with the operating condition from the map (or table). Then, in step S160, the control device 50 calculates the number of particles. This reduces the computational load on the control device 50 and thus enables rapid calculation of the number of particles.

In the embodiment described above, the rotational speed and the torque of the engine are used as operating conditions of the engine, by way of example but not limitation. Alternatively or additionally, the amount of fuel injection, the amount of air suction, the vehicle speed, and so on may be used.

In the embodiment described above, the electric field generation electrodes 32 and 42 are disposed along the inner surface of the gas flow channel 13. Alternatively, the electric field generation electrodes 32 and 42 may be embedded in the wall of the gas flow channel 13 (the housing 12). As illustrated in FIG. 10, in place of the electric field generation electrode 32, a pair of electric field generation electrodes 34 and 36 may be embedded in the wall of the gas flow channel 13 in such a manner as to interpose the excess charge removal electrode 30 therebetween, and, in place of the electric field generation electrode 42, a pair of electric field generation electrodes 44 and 46 may be embedded in the wall of the gas flow channel 13 in such a manner as to interpose the collection electrode 40 therebetween. In this case, when an electric field is generated on or above the excess charge removal electrode 30 by application of a voltage between the pair of electric field generation electrodes 34 and 36, charges are collected by the excess charge removal electrode 30. When an electric field is generated on or above the collection electrode 40 by application of a voltage between the pair of electric field generation electrodes 44 and 46, charged particles are collected by the collection electrode 40.

In the embodiment described above, the charge generation element 20 is constituted by the needle-shaped electrode 22 and the counter electrode 24. Alternatively, the charge generation element 20 may have any configuration for generating charges by gaseous discharge. For example, an ground electrode may be embedded in the wall of the gas flow channel 13, and a discharge electrode may be disposed on the inner surface of the gas flow channel 13 at a position facing the ground electrode. In this case, a portion of the housing 12 between the discharge electrode and the ground electrode serves as a dielectric layer, and thus charges can be generated by dielectric barrier discharge.

In the embodiment described above, an electric field is generated on or above the collection electrode 40. However, even if no electric field is generated, the space (passage thickness) where the collection electrode 40 is provided in the gas flow channel 13 is adjusted to a small value (for example, 0.01 mm or more and less than 0.2 mm), thereby allowing the collection electrode 40 to collect charged particles. That is, due to rapid Brownian movement of charged particles, the passage thickness that is set to a small value allows the charged particles to hit the collection electrode 40 such that the collection electrode 40 collects the charged particles. In this case, the electric field generation electrode 42 may not be included.

While the embodiment described above describes the measurement of the number of charged particles that are positively charged, even for charged particles that are negatively charged, the number of particles may be measured in a similar way.

In the embodiment described above, the temperature of the exhaust gas is acquired from the gas temperature sensor 56. If the gas temperature sensor 56 is not attached to the exhaust pipe of the engine, the temperature of the exhaust gas may be estimated from any other parameter (for example, the torque of the engine and rotational speed).

This application claims priority based on Japanese Patent Application No. 2017-170810 filed Sep. 6, 2017, which is hereby incorporated by reference herein in its entirety.

What is claimed is:

1. A particle counter comprising:
a housing having a gas flow channel;
a charge generation unit that applies charges generated by discharge to particles in a gas introduced into the gas flow channel to generate charged particles;
a collection electrode that is disposed downstream of the charge generation unit in a flow of the gas and that collects the charged particles; and
a counting unit that determines the number of particles in the gas on the basis of a physical quantity that changes in accordance with the number of charged particles collected by the collection electrode, wherein
the counting unit determines an average number of charges on the particles using a relationship between a particle diameter and a probability density of the particles and a relationship between the particle diameter and the number of charges on the particles, and determines the number of particles in the gas using the physical quantity and the average number of charges on the particles.

2. The particle counter according to claim 1,
wherein the gas comprises an exhaust gas of an engine, and the counting unit determines the relationship between the particle diameter and the probability density of the particles on the basis of an operating condition of the engine.

3. The particle counter according to claim 2,
wherein the operating condition of the engine comprises a rotational speed and a torque of the engine.

4. The particle counter according to claim 1,
wherein the counting unit determines the average number of charges on the particles by accumulating products each obtained by multiplying the number of charges for a particle diameter of one of the particles and a probability density for a particle diameter of one of the particles.

5. The particle counter according to claim 1,
wherein the counting unit determines the relationship between the particle diameter and the number of charges on the particles with consideration given to at least one of a temperature of the gas or a flow velocity of the gas.

6. The particle counter according to claim 1,
wherein the counting unit determines the relationship between the particle diameter and the number of charges on the particles by using a power approximation formula that takes into consideration at least one of a temperature of the gas or a flow velocity of the gas.

7. The particle counter according to claim 1, further comprising:
an excess charge removal electrode that is disposed between the charge generation unit and the collection electrode and that removes excess charges not applied to the particles.
